(19) United States
(12) Patent Application Publication
(10) Pub. No.: US 2026/0114489 A1
(43) Pub. Date: Apr. 30, 2026

(54) DRY PARTICLE COATING TO PRODUCE STABLE POWDERS

(71) Applicant: GIVAUDAN SA, VERNIER (CH)

(72) Inventors: Giuseppe CORDA, Naarden (NL); Camille DURAND, Avignon (FR); Rudolf RINGGENBERG, Kemptthal (CH)

(21) Appl. No.: 19/142,177

(22) PCT Filed: Dec. 20, 2023
(86) PCT No.: PCT/EP2023/087140

§ 371 Date: Jun. 20, 2025

Related U.S. Application Data
(60) Provisional application No. 63/434,631, filed on Dec. 22, 2022.

(51) Int. Cl. A23P 20/12; A23L 19/00; A23P 10/30

(52) U.S. Cl. CPC A23P 20/12; A23L 19/01; A23P 10/30

(57) ABSTRACT

Methods of making stable, dry coated fruit powders are provided. The methods include providing a fruit powder; selecting a hydrophobic stearate guest particle from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate, and decaglyceryl monostearate; and dry coating the fruit powder with the hydrophobic stearate guest particles using high shear. The hydrophobic stearate guest particles are dry coated with respect to the fruit powder at levels between about 1 and 10 wt % in order to form a continuous layer.

### TECHNICAL FIELD

The present disclosure relates to moisture and oxygen stable fruit powders and methods of producing such powders. More particularly, the present disclosure relates to a method for preparing stable fruit powders using a dry particle coating technique. The disclosure is further concerned with powders suitable for topical application to food products, such as snack foods.

### BACKGROUND

Hygroscopic powders, for example, fruit powders typically have poor physical stability which leads to handling issues and customer complaints. In order to solve this problem, dry particle coating may be used to create new-generation materials by combining different powders having different physical and chemical properties to form composites. These new-generation materials exhibit unique functionalities and/or improved characteristics relative to known materials. In particular, powders with relatively large particle sizes (host particles: 1-1500 μm) are mechanically coated with fine particles (guest particles: 0.1-50 μm) without using solvents and subsequent drying, in order to create a new functionality or to improve their initial characteristics, including improved handling and shelf stability.

Accordingly, there remains a need for processing techniques and methodologies for fruit powders that achieve advantageous stability benefits. There also remains a need for processing techniques and methodologies for powders used in snack seasonings in order to reduce or eliminate the tendency to clump or cake.

These and other benefits are achieved through the methods disclosed herein.

### SUMMARY

In one embodiment, a method of making stable, dry coated fruit powder comprises the steps of providing a fruit powder; selecting a hydrophobic stearate guest particle from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate, decaglyceryl monostearate; and dry coating the fruit powder with hydrophobic stearate guest particles using high shear; wherein the hydrophobic stearate guest particles are dry coated with respect to the fruit powder at levels between about 1 and about 10 wt % in order to form a continuous layer.

In another embodiment, a stable fruit powder comprises an acerola fruit powder dry coated with a hydrophobic guest particle at levels between about 1 and 10 wt % in order to form a continuous layer.

In another embodiment, a solid flavour composition comprises a plurality of individual components at least one of which is a flavour-providing substance and at least one of which is an auxiliary component, wherein the auxiliary component comprises a sodium diacetate or lactic acid powder dry coated with a hydrophobic guest particle at levels between about 0.2 and about 15 wt % in order to form a continuous layer.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 is a schematic representation of steps of a dry particle coating technique according to embodiments shown and described herein.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

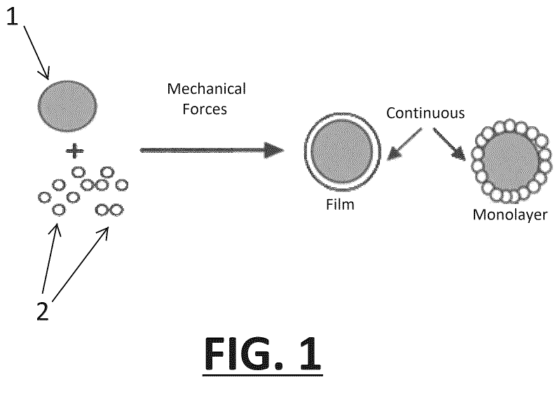

The present disclosure relates to the surprising finding that applying dry particle coating processes to hygroscopic fruit powders makes it possible to increase the shelf life of the powder. FIG. 1 is a schematic representation of a dry particle coating technique, i.e. dry coating host particle 1 with guest particles 2 by subjecting the combined particles to mechanical forces such as in a high shear mixer, resulting in a continuous layer of guest particles 2 on the surface of the host particle 1. As indicated in FIG. 1, the continuous layer may be a film or a monolayer.

### Powder Host Particles

In accordance with one embodiment, the present disclosure relates to a dry particle coating method that uses a fruit powder(s) (host particles) mechanically coated with finer particles (guest particles) in order to increase handling and stability of the fruit powder(s).

The term “fruit powder” includes fruit extract powder and fruit juice powder. In one embodiment, a host particle in accordance with the present disclosure may comprise a fruit extract powder. In one example, suitable fruit extract powders include, but are not limited to, extracts obtained from acerola, apple, grape, prune, apricot, orange, mango, lemon, raspberry, cranberry, blueberry, mulberry, elderberry and combinations thereof. The term “fruit extract” refers to the extract obtained from the fruit, including the whole fruit, and/or skin of the fruit, and/or the pulp and/or the residues of the fruit after juicing of the fruit. The fruit or the parts may be fresh, frozen or dried. Juice that is recovered from any processing of the fruit can also be processed to recover a fruit extract. In another embodiment, a host particle in accordance with the present disclosure may comprise a fruit juice powder. In one example, suitable fruit juice powders include, but are not limited to, juice obtained from acerola, apple, grape, prune, apricot, orange, mango, lemon, raspberry, cranberry, blueberry, mulberry, elderberry and combinations thereof. The term “fruit juice powder” refers to a powder made from the juice of fresh fruit and then dried.

In one embodiment, the fruit powder is from acerola. Malpighia emarginata and Malpighia glabra are tropical fruit-bearing shrubs or small trees in the family Malpighiaceae.

Common names include acerola cherry, Guarani cherry, Barbados cherry, West Indian cherry, and wild crepe myrtle. Acerola is native to Paraguay and Brazil in South America, Central America and southern Mexico, Puerto Rico, Dominican Republic and Haiti. It is a rich source of vitamin C. Acerola also contains many minerals and other vitamins, including beta-carotene, lutein, thiamine, riboflavin, niacin, pyridoxine, folic acid, and pantothenic acid. Acerola is commonly used to prevent vitamin C deficiency.

The term “acerola fruit powder” refers to the extract obtained from the acerola fruit, including the whole fruit, and/or skin of the acerola fruit, and/or the pulp and/or the residues of the fruit after juicing of the fruit. The fruit or the parts may be fresh, frozen or dried. Juice that is recovered from any processing of the fruit any also be processed to recover an acerola fruit extract. In a particular embodiment, the acerola fruit powder is an acerola extract powder. In another embodiment, the acerola fruit powder is an acerola juice powder. In another embodiment, the acerola fruit powder contains vitamin C, antioxidant polyphenolic compounds, fiber, glucose, fructose, anthocyanin and polyunsaturated fatty acids (PUFA).

Vitamin C (also known as ascorbic acid and ascorbate) is a water-soluble vitamin found in citrus and other fruits and vegetables, and also sold as a dietary supplement. Vitamin C is an essential nutrient involved in the repair of tissue, the formation of collagen, and the enzymatic production of certain neurotransmitters. It is required for the functioning of several enzymes and is important for immune system function. It also functions as an antioxidant. In one embodiment, the acerola fruit powder contains at least 25% of vitamin C. In another embodiment, the acerola fruit powder contains from about 25% to about 40% of vitamin C. In yet another embodiment, the acerola fruit powder contains from about 28% to about 34% of vitamin C.

In another particular embodiment, the acerola fruit powder may contain other components such as a pH modifier or an acidity regulator. pH modifiers, acidity regulators, or pH control agents, are additives used to change or maintain pH (acidity or basicity). They can be organic or mineral acids, bases, neutralizing agents, or buffering agents. In a particular embodiment, the acerola fruit powder contains magnesium hydroxide as an acidity regulator According to the present disclosure, the acerola fruit powder can be from green or red acerola fruit. The colour difference between red and green acerola, is attributed to the ripeness of the fruit. Green acerola is harvested whilst the fruit is still unripe, and red acerola is harvested once the fruit has fully matured. Thus, in a particular embodiment, the acerola fruit powder for use in the first method of the invention is a red acerola fruit powder. In another particular embodiment, the acerola fruit powder for use in the first method of the invention is a green acerola fruit powder.

In one embodiment, the fruit powder (host particles) have an average size of from about 1 μm to about 1500 μm; in another embodiment from about 1 μm to about 800 μm; and in yet another embodiment from about 100 μm to about 500 μm.

In another embodiment, the powder host particles are used in seasoning compositions. For these applications, the powder host particles may be selected from the group consisting of sodium diacetate, lactic acid and combinations thereof and they have an average size of from about 1 μm to about 1500 μm; in another embodiment from about 1 μm to about 800 μm; and in yet another embodiment from about 100 μm to about 500 μm.

### Hydrophobic Guest Particles

As mentioned above, in accordance with one embodiment, the present disclosure relates to a dry particle coating method that uses a fruit powder(s) (host particles) mechanically coated with finer particles (guest particles) in order to increase handling and stability of the fruit powder(s).

In one embodiment, guest particles in accordance with the present disclosure may comprise hydrophobic stearate particles. In one embodiment, the hydrophobic stearate particles may be selected from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate, decaglyceryl monostearate and combinations thereof. In another embodiment, guest particles may be selected from starches, silica, amino acids, cellulose, bentonite and combinations thereof. In another embodiment, any suitable hydrophobic excipient may be used, for example, sorbitan esters of lauric acid, sorbitan esters of oleic acid, cetyl alcohol, glyceryl monostearate, glyceryl dibehenate, and glyceryl palmito-stearic ester.

In one embodiment, the hydrophobic stearate guest particles have an average size of from about 0.1 μm to about 50 μm; in another embodiment from about 0.2 μm to about 20 μm; and in yet another embodiment from about 0.5 μm to about 15 μm.

According to the present disclosure, in order to improve the stability of the fruit powder, the hydrophobic stearate guest particles are dry coated onto the fruit powder forming a target of 100% surface coverage of the host particles with a continuous layer of guest particles in order to form a hydrophobic barrier. In one embodiment the continuous layer may be a monolayer. In another embodiment, the continuous layer may be a film. In one embodiment, the percentage of hydrophobic guest particles needed to coat fruit powder is determined to be between about 1% and about 10%, by weight of the fruit powder; in another embodiment, between about 2% and about 5%, by weight of the fruit powder; and in yet another embodiment, about 3% by weight of the fruit powder.

The particles according to the present disclosure may be produced using a dry particle coating process. A TMG high shear mixer (0.1 to 4.5 liters capacity) available from Glatt GmbH is used for the coating examples. The mixer is a wet granulator with flexible, temperature-controlled working vessels for mixing and granulating powders. Integrated touch panel and GMP-compliant design, time-saving installation and easy to operate. The vessels can be equipped with powder funnels and various spray nozzles. Other technologies may be used, including a resonant acoustic mixer available from Resodyn Acoustic Mixers.

Conditions may naturally vary depending on the nature of the equipment and the material being coated, but the person skilled in the art can readily determine the appropriate conditions in every case with only routine experimentation. For example, the fruit powder is loaded into the mixing vessel from the top, followed by the guest particles. Together, mechanical forces are applied to the mixture by maintaining the agitator at a rotation speed between 250 rpm and 1000 rpm, for example 400 rpm, and a chopper rotational speed between 50 rpm and 3000 rpm, for example 300 rpm, for a period of time between 2 minutes and 40 minutes, for example 5 minutes. Further, the temperature is maintained in a range of from about 10° C. to about 40° C.

In accordance with the present disclosure, the fruit powder after being dry coated may be formulated in solid, semi-solid or liquid preparations, such as tablets, capsules, powders, granules, solutions, suppositories, gels, microspheres and/or any other form known in the food, medical device, cosmetic and/or pharmaceutical art. In a particular embodiment, the compositions are formulated for administration in solid, tablet form.

In another particular embodiment, the solid formulation is selected from the group consisting of tablets, lozenges, candies, chewable tablets, chewing gums, capsules, sachets, powders, granules, coated particles or coated tablets, tablets, pills, gastro-resistant tablets and capsules, and dispersible strips and films.

In another particular embodiment, the liquid formulation is selected from the group consisting of oral solutions, suspensions, emulsions and syrups.

In addition to what is described above, the present invention also covers the possibility that the compositions may be administered to a subject together with other components or compounds, even if these do not form part of the composition. In one embodiment, the present disclosure relates to a food supplement which comprises an acerola fruit extract. The term “food supplement” refers to products or preparations intended to supplement the normal diet of a subject and consisting of concentrated nutrient sources or other substances with a nutritional or physiological effect.

In another particular aspect, the present disclosure relates to a dietary supplement which comprises an acerola fruit extract. The term “dietary supplement” refers to a manufactured product intended to supplement the diet.

The food supplement or the dietary supplement may be in single or combined form and marketed in dosage form, i.e. in capsules, pills, tablets and other similar forms, powder sachets, liquid ampoules and drop dispensing bottles and other similar forms of liquids and powders designed to be taken in a single quantity. There is a wide range of nutrients and other elements that may be present in food supplements, including vitamins, minerals, amino acids, essential fatty acids, fiber, enzymes, plants, plant extracts, mushrooms and fungal extracts. Since their function is to supplement the nutrient supply of the diet, they should not be used as a substitute for a balanced diet and their intake should not exceed the daily dose expressly recommended by a doctor or nutritionist.

As mentioned above, in accordance with one embodiment, the present disclosure relates to a dry particle coating method that uses a powder(s) mechanically coated with finer particles (guest particles) in order to increase handling and stability of snack seasonings.

According to one embodiment, there is disclosed a solid flavour composition comprising a plurality of individual components at least one of which is a flavour-providing substance and at least one of which is an auxiliary component, wherein the auxiliary component comprises a sodium diacetate or lactic acid powder dry coated with a guest particle at levels between about 0.2 and about 15 wt % in order to form a continuous layer.

With respect to snack seasonings, the guest particles in accordance with the present disclosure may comprise hydrophobic stearate particles. In one embodiment, the hydrophobic stearate particles may be selected from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate, decaglyceryl monostearate and combinations thereof. In another embodiment, guest particles may be selected from starches, silica, amino acids, cellulose, bentonite and combinations thereof. In another embodiment, any suitable hydrophobic excipient may be used, for example, sorbitan esters of lauric acid, sorbitan esters of oleic acid, cetyl alcohol, glyceryl monostearate, glyceryl dibehenate, and glyceryl palmito-stearic ester.

In one embodiment, the hydrophobic stearate guest particles have an average size of from about 0.1 μm to about 50 μm; in another embodiment from about 0.2 μm to about 20 μm; and in yet another embodiment from about 0.5 μm to about 15 μm.

The powders formed by dry particle coating may be used to prepare shelf stable flavour compositions that exhibit a superior flow index (flowability parameter) that can be topically coated on to food products.

The at least one flavour-providing substance in the flavour composition is selected in such a way as to impart or modify in a positive or pleasant way, the taste and/or aroma of a food product. The nature and type of the at least one flavour-providing substance present in the flavour composition does not warrant a particularly exhaustive description here, the skilled person being able to select them on the basis of its general knowledge and according to intended use or application and the desired organoleptic effect. In general terms, these substances belong to chemical classes as varied as alcohols, aldehydes, ketones, esters, ethers, acetates, nitriles, terpenoids, nitrogenous or sulphurous heterocyclic compounds and essential oils, and can be of natural or synthetic origin. Many of the flavour-providing substances useful in the flavour composition are described in reference texts such as the book by S. Arctander, Perfume and Flavour Chemicals, 1969, Montclair, N.J., USA, or its more recent versions, or in other works of a similar nature, as well as in the patent literature in the field of flavours and seasonings.

According to certain embodiments, the flavour composition may include one or more of the following types of ingredients: a tastant, such as salts, acids, such as citric, malic, tartaric, fumaric, lactic, acetic, malic, lactic and succinic acid sweeteners or mixtures thereof; tastant enhancers, such as MSG and ribonucleotides; dairy powders, e.g. whey powders, fat powders, creamers and the like; minerals, such as calcium phosphate, tri-potassium phosphate, or ammonium chloride; natural, nature identical or artificial flavours that are useful in culinary or savoury snack food applications, to provide a particular taste and/or aroma such as natural and/or synthetic flavour chemicals, flavour oils, essential oils and oleoresins; and ingredients that alter the body or mouthfeel of a seasoning, or which impart an organoleptic effect other than taste or aroma, such as tingling, salivating, lingering, succulence, heating, or an off-note masking effect, or mixtures thereof, such as any of the essential amino acids or mixtures thereof and food acids or mixtures thereof.

The at least one flavour-providing substance may comprise flavour oils, such as cinnamon oil, bay oil, anise oil, thyme oil, cedar leaf oil, oil of nutmeg, allspice, oil of sage, mace, oil of bitter almonds, and cassia oil; artificial, natural and synthetic flavours such as a cheese flavour, a fennel flavour, an all spice flavour, a cinnamon flavour, a mustard flavour, a cardamom flavour, a caraway flavour, a cumin flavour, a clove flavour, a pepper flavour, a coriander flavour, a savoury flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bay leaf flavour, and a wasabi flavour; a nut flavour such as an almond flavour, a hazelnut flavour, a macadamia nut flavour, a peanut flavour, a pecan flavour, a pistachio flavour, and a walnut flavour; and vegetable flavours, such as an onion flavour, a garlic flavour, a cabbage flavour, a carrot flavour, a celery flavour, mushroom flavour, and a tomato flavour.

Particular flavour-providing substances include salty, bitter, sweet and umami tastants, and also including savoury (e.g. kokumi) tastants. Non limiting examples include: NaCl, KCl, MSG, guanosine monophosphate (GMP), inosin monophospahte (IMP), ribonucleotides such as disodium inosinate, disodium guanylate, N-(2-hydroxyethyl)-lactamide, N-lactoyl-GMP, N-lactoyl tyramine, gamma amino butyric acid, allyl cysteine, 1-(2-hydroxy-4-methoxylphenyl)-3-(pyridine-2-yl)propan-1-one, arginine, potassium chloride, ammonium chloride, succinic acid, N-(2-methoxy-4-methyl benzyl)-N′-(2-(pyridin-2-yl)ethyl) oxalamide, N-(heptan-4-yl)benzo(D)(1,3)dioxole-5-carboxamide, N-(2,4-dimethoxybenzyl)-N′-(2-(pyridin-2-yl)ethyl) oxalamide, N-(2-methoxy-4-methyl benzyl)-N′-2(2-(5-methyl pyridin-2-yl)ethyl) oxalamide, and cyclopropyl-E,Z-2,6-nonadienamide.

In certain embodiments, the at least one flavour-providing substance is present in an amount of about 1 to about 95 wt. %, based on the total weight of the flavour composition. In certain embodiments, the at least one flavour-providing substance is present in an amount of about 1 to about 70 wt. %, based on the total weight of the flavour composition. In certain embodiments, the at least one flavour-providing substance is present in an amount of about 5 to about 60 wt. %, based on the total weight of the flavour composition. In certain embodiments, the at least one flavour-providing substance is present in an amount of about 10 to about 50 wt. %, based on the total weight of the flavour composition.

In certain embodiments, the auxiliary component is present in an amount of about 0.05 to about 3 wt. %, based on the total weight of the flavour composition. In certain embodiments, the auxiliary component is present in an amount of about 0.5 to about 1.5 wt. %, based on the total weight of the flavour composition.

Seasoning compositions as hereinabove described may be applied topically to all manner of farinaceous or starch-based snack food known in the art. Particular snack foods include potato chips, crisps, nuts, tortilla-tostada, pretzels, cheese snacks, corn snacks, potato-snacks, ready-to-eat popcorn, microwaveable popcorn, pork rinds, nuts, crackers, and other baked or extruded food products.

The disclosure is further described with reference to the following non-limiting examples.

### Examples

The following examples are given solely for the purpose of illustration and are not to be construed as limitations of the present invention, as many variations of the invention are possible without departing from the spirit and scope of the present disclosure.

Samples of the fruit powder were prepared using a dry particle coating process in a TMG high shear mixer from Glatt as follows:
Control A (Acerola KEK 0.5 powder produced by Givaudan with a particle size of less than 0.5 mm)
Control B (Acerola S12 powder produced by Givaudan with a particle size of less than 1.2 mm)
Example 1 (225 g of Acerola KEK 0.5+25 g of calcium stearate (10 wt %)) were placed in the high shear mixer and mechanical forces applied by maintaining the agitator at a rotation speed of 400 rpm and a chopper rotational speed of 300 rpm for a time of 5 minutes.
Example 2 (225 g of Acerola S12+25 g of calcium stearate (10 wt %)) were placed in the high shear mixer and mechanical forces applied by maintaining the agitator at a rotation speed of 400 rpm and a chopper rotational speed of 300 rpm for a time of 5 minutes.
Example 3 (Blend of 225 g of Acerola KEK 0.5/225 g of Acerola S12+50 g of calcium stearate (10 wt %)) were placed in the high shear mixer and mechanical forces applied by maintaining the agitator at a rotation speed of 400 rpm and a chopper rotational speed of 300 rpm for a time of 7 minutes.

Control Samples A and B and Examples 1-3 were stored in an open cup at 20° C. and 33% relative humidity. The samples were checked after 0, 24, and 96 hours. The samples were placed and stored into desiccators containing specified humidity levels. For Control Samples A and B and Examples 1-3 33% (aw=0.33) was used. The water activity (aw) was analysed based on ISO 18787: 2017, Foodstuffs—Determination of water activity method using an Aqualab TDL water activity meter from Meter Group. The results are shown in Table 1, below, in which:
1=powdery, no change from original
2=some small lumps visible
3=larger visible lumps, starts caking

TABLE 1
(aw = 0.33)

| | Time (hours) | | |
|---|---|---|---|
| | 0 | 24 | 96 |
| Control A | 1 | 1 | 3 |
| Control B | 1 | 1 | 3 |
| Ex. 1 | 1 | 1 | 1 |
| Ex. 2 | 1 | 1 | 1 |
| Ex. 3 | 1 | 1 | 1 |

Fruit powder made using the dry particle coating method according to the present disclosure (Examples 1-3) remained more stable, free flowing and had a more favorable (higher) water activity, than fruit powder alone (Control A and B).

Additional samples of the fruit powder were prepared using a dry particle coating process in a TMG high shear mixer from Glatt as follows:
Control C (Acerola Green 34% Vitamin C was produced by Givaudan)
Example 4 (225 g of Acerola Green 34% Vitamin C+11.85 g of calcium stearate (5 wt %)) were placed in the high shear mixer and mechanical forces applied by maintaining the agitator at a rotation speed of 700 rpm and a chopper rotational speed of 700 rpm for a time of 7 minutes. Tₛₜₐᵣₜ=18° C. and T_{end}=22.7° C.
Example 5 (225 g of Acerola Green 34% Vitamin C+5.8 g of calcium stearate (2.5 wt %)) were placed in the high shear mixer and mechanical forces applied by maintaining the agitator at a rotation speed of 700 rpm and a chopper rotational speed of 700 rpm for a time of 7 minutes. Tₛₜₐᵣₜ=18° C. and T_{end}=25.1° C.
Example 6 (225 g of Acerola Green 34% Vitamin C+2.85 g of calcium stearate (1.25 wt %)) were placed in the high shear mixer and mechanical forces applied by maintaining the agitator at a rotation speed of 700 rpm and a chopper rotational speed of 700 rpm for a time of 7 minutes. Tₛₜₐᵣₜ=18° C. and T_{end}=27.1° C.

Control Sample C and Examples 4-6 were stored in an open cup at 30° C. and 43% relative humidity. The samples were checked after 0, 24 and 96 hours. The samples were placed and stored into desiccators containing specified humidity levels. For Control Sample C and Examples 4-6 43% (aw=0.43) was used. The water activity (aw) was analysed based on ISO 18787: 2017, Foodstuffs—Determination of water activity method using an Aqualab TDL water activity meter from Meter Group. The results are shown in Table 2, below, in which:
1=powdery, no change from original
2=some small lumps visible
3=larger visible lumps, starts caking

TABLE 2
(aw = 0.43)

| | Time (hours) | | |
|---|---|---|---|
| | 0 | 24 | 96 |
| Control C | 1 | 1 | 3 |
| Ex. 4 | 1 | 1 | 1 |
| Ex. 5 | 1 | 1 | 1 |
| Ex. 6 | 1 | 1 | 2 |

Fruit powder made using the dry particle coating method according to the present disclosure (Examples 4-6) remained more stable, free flowing and had a more favorable (higher) water activity, than fruit powder alone (Control C).

Additional samples of a dry coated sodium diacetate for use in snack seasonings were prepared using a dry particle coating process in a TMG high shear mixer from Glatt as follows:
Control D (sodium diacetate)
Example 7 (950 g of sodium diacetate+50 g of calcium stearate (5 wt %)) were placed in the high shear mixer and mechanical forces applied by maintaining the agitator at a rotation speed of 1000 rpm and a chopper rotational speed of 30000 for a time of 10 minutes.

Control Sample D and Example 7 were stored in an open cup at 20° C. The samples were checked after 0, 1, 2 and 3 weeks. The water activity (aw) was analysed based on ISO 18787: 2017, Foodstuffs—Determination of water activity method using an Aqualab TDL water activity meter from Meter Group. The shelf life results are shown in Tables 3a (0.33 aw) and 3b (0.43 aw) below, in which:
1=powdery, no change from original
2=some small lumps visible
3=larger visible lumps, starts caking

TABLE 3a
(0.33 aw)

Time (weeks)

| | 0 | 1 | 2 | 3 |
|---|---|---|---|---|
| Control D | 1 | 2 | 2 | 3 |
| Ex. 7 | 1 | 1 | 1 | 1 |

TABLE 3b
(0.43 aw)

Time (weeks)

| | 0 | 1 | 2 | 3 |
|---|---|---|---|---|
| Control D | 1 | 2 | 2 | 3 |
| Ex. 7 | 1 | 1 | 1 | 1 |

Dry coated sodium diacetate made using the dry particle coating method according to the present disclosure (Example 7) remained more stable, free flowing, than sodium diacetate powder alone (Control D).

Additional samples of a snack seasoning were prepared using a dry particle coating process in a TMG high shear mixer from Glatt as follows:
Control E (salt & vinegar seasoning produced by Givaudan)
Example 8 (salt & vinegar seasoning+Example 7).

Control Sample E and Example 8 were stored in LD barrier bags at 25° C. and 50% relative humidity. The samples were checked after 0, 1, 2, 3, 4, 5 and 6 months. The shelf life results are shown in Table 4 below, in which:
1=powdery, no change from original
2=some small lumps visible
3=larger visible lumps, starts caking

TABLE 4

Time (months)

| | 0 | 1 | 2 | 3 | 4 | 5 | 6 |
|---|---|---|---|---|---|---|---|
| Control E | 1 | 1 | 2 | 2 | 2 | 2 | 3 |
| Ex. 8 | 1 | 1 | 1 | 1 | 1 | 1 | 1 |

Snack seasoning containing a dry coated sodium diacetate made using the dry particle coating method according to the present disclosure (Example 8) remained more stable, free flowing, than snack seasoning alone (Control E).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of making stable, dry coated fruit powder, comprising:
providing a fruit powder;
selecting a hydrophobic stearate guest particle from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate, and decaglyceryl monostearate; and
dry coating the fruit powder with the hydrophobic stearate guest particles using high shear;
wherein the hydrophobic stearate guest particles are dry coated with respect to the fruit powder at levels between about 1 and 10 wt % in order to form a continuous layer.

2. The method according to claim 1, wherein the fruit powder is from acerola.

3. The method according to claim 2, wherein the acerola fruit powder is red acerola fruit extract or green acerola fruit extract.

4. The method according to claim 2, wherein the acerola fruit powder contains at least 25% vitamin C.

5. The method according to claim 1, wherein the fruit powder has an average particle size of from about 100 μm to about 500 μm.

6. The method according to claim 1, wherein the hydrophobic stearate guest particles have an average particle size of from about 0.5 μm to about 15 μm.

7. The method according to claim 1, wherein the fruit powder is selected from the group consisting of apple, grape, prune, apricot, orange, mango, lemon, raspberry, cranberry, blueberry, mulberry, elderberry and combinations thereof.

8. The method according to claim 1, wherein the continuous layer formed by the hydrophobic stearate guest particles is a monolayer.

9. The method according to claim 1, wherein the continuous layer formed by the hydrophobic stearate guest particles is a film.

10. A stable fruit powder comprising:
an acerola fruit powder dry coated with hydrophobic guest particles at levels between about 1 and 10 wt % in order to form a continuous layer.

11. The fruit powder according to claim 10, wherein the hydrophobic guest particle is a stearate selected from the group consisting of ammonium stearate, zinc stearate, calcium stearate, sodium stearate, potassium stearate, magnesium stearate, glyceryl stearate, propylene glycol monostearate, sorbitan stearate, triglyceryl monostearate, hexaglyceryl distearate and decaglyceryl monostearate.

12. The fruit powder according to claim 10, wherein the hydrophobic guest particle is selected from the group consisting of starches, silica, amino acids, cellulose, bentonite and combinations thereof.

13. The fruit powder according to claim 10, wherein the acerola fruit powder is dry coated using high shear.

14. The fruit powder according to claim 10, wherein the fruit powder has an average particle size of from about 100 μm to about 500 μm.

15. The fruit powder according to claim 10, wherein the hydrophobic guest particles have an average particle size of from about 0.5 μm to about 15 μm.

16. (canceled)

17. (canceled)

18. (canceled)

19. (canceled)

20. (canceled)
